(19) United States
(12) Patent Application Publication
(10) Pub. No.: US 2020/0104085 A1
(43) Pub. Date: Apr. 2, 2020

(54) PRINTING APPARATUS, CONTROL METHOD, AND STORAGE MEDIUM THEREOF

(71) Applicant: CANON KABUSHIKI KAISHA, Tokyo (JP)

(72) Inventor: Ritsuto Sako, Tokyo (JP)

(21) Appl. No.: 16/577,949

(22) Filed: Sep. 20, 2019

(30) Foreign Application Priority Data
Sep. 28, 2018 (JP) 2018-185424

(51) Int. Cl. G06F 3/12; H04L 29/08; H04N 1/00

(52) U.S. Cl. CPC G06F 3/1288; H04L 67/10; H04N 1/00877; H04N 1/0097; H04N 1/00973; G06F 3/1229

(57) ABSTRACT

A printing unit determines one method based on a user setting from among two methods of a first method of printing a print job for a cloud account associated with a user account under a condition that a login process has been performed by a login unit, and a second method of printing a print job notified by an event notification in response to receiving the event notification from a cloud print service even when the login process has not been performed by the login unit, and the printing unit prints a print job by the determined one method.

### BACKGROUND

### Field of the Disclosure

The present disclosure relates to a printing apparatus, a control method, and a storage medium thereof in cloud print services.

### Description of the Related Art

In print services so far, printing has been achieved by a user transmitting a print job directly from a client terminal such as a personal computer (PC) to a printing apparatus. On the other hand, in recent years, a cloud print service using a cloud service provided on the Internet has been discussed.

A processing sequence of cloud printing which has been conventionally known will be described below with reference to FIG. 1. It is assumed that a printing apparatus 101 supports a cloud print function and a web user interface (WebUI) function for operating the printing apparatus 101. It is also assumed that a client terminal 100 supports a cloud print client function and a WebUI client for operating the WebUI. Further, a cloud print service 102 refers to a cloud print service on the Internet.

A user first uses the WebUI client of the client terminal 100 to transmit a cloud print service registration request 111 to the printing apparatus 101 through the WebUI. If receiving the request 111, the printing apparatus 101 transmits a cloud print service registration request 112 to the cloud print service 102. If receiving the request 112, the cloud print service 102 transmits, to the printing apparatus 101, a cloud print service registration request response 113 including a registration uniform resource locator (URL) 130 for cloud print registration. If receiving the response 113, the printing apparatus 101 transmits, to the client terminal 100 through the WebUI, registration URL displayed screen information 114 including the cloud print service registration URL.

If receiving the screen information 114, the client terminal 100 displays the registration URL on the WebUI client. The user operates the WebUI client of the client terminal 100 to access the displayed registration URL. Thus, the client terminal 100 transmits, to the cloud print service 102, a cloud print service registration approval request 115 including a cloud account 131. If receiving the registration approval request 115, the cloud print service 102 transmits, to the client terminal 100, a cloud print service registration approval response 116. The user authorized to use the cloud print service 102 is represented by the cloud account 131, and the user has registered the user account with the cloud print service 102 in advance.

The printing apparatus 101 transmits a cloud print service registration confirmation request 117 to the cloud print service 102. If receiving the registration confirmation request 117, the cloud print service 102 transmits, to the printing apparatus 101, a cloud print service registration confirmation response 118 including a cloud printer ID 132. At this stage, the printing apparatus 101 is brought into a state where the printing apparatus 101 is registered with the cloud print service 102, and accordingly brought into a state where the printing apparatus 101 is allowed to use the cloud print service.

The client terminal 100 transmits a printing request 119 including the cloud printer ID 132, print data 134, and the cloud account 131 to the cloud print service 102. The printing apparatus 101 transmits, to the cloud print service 102, a print job request 120. The cloud print service 102 transmits, to the printing apparatus 101, a print job response 121 including the print data 134 and the cloud account 131. The printing apparatus 101 prints the received print data.

The print job request 120 in the sequence of FIG. 1 is transmitted by the printing apparatus 101 when the printing apparatus 101 detects that a print job addressed to the printing apparatus 101 itself has been transmitted to the cloud print service 102. Specifically, such a detection method is achieved by receiving an event notification in the printing apparatus 101 from the cloud print service 102.

A conventional technique related to a printing apparatus using a cloud service is discussed in, for example, Japanese Patent No. 5853996. In a printing apparatus using a plurality of cloud services, when a user desires to know information such as the usage fee of each of the cloud services, it is necessary for the user to log in to and confirm each of the cloud services individually. The printing apparatus discussed in Japanese Patent No. 5853996 saves account IDs and passwords of a plurality of cloud services in advance. When the user logs in to the printing apparatus, the printing apparatus logs in to the plurality of cloud services registered in advance, acquires the latest information, and displays the latest information on a display of its own device.

### SUMMARY

According to embodiments of the present disclosure, a printing apparatus includes a printing unit configured to acquire a print job from a cloud print service and perform printing based on the acquired print job. The printing apparatus includes a setting unit configured to perform a setting for associating a user account for the printing apparatus with a cloud account for the cloud print service, and a login unit configured to perform a process of logging in to the printing apparatus based on the user account. In the printing apparatus, the printing unit determines one method, based on a user setting, from among two methods of a first method of printing a print job for the cloud account associated with the user account under a condition that the process of logging in to the printing apparatus has been performed by the login unit, and a second method of printing a print job notified by a print job notification in response to receiving the print job notification from the cloud print service even when the process of logging in to the printing apparatus has not been performed by the login unit, and the printing unit prints a print job by the determined one method.

Further features of the present disclosure will become apparent from the following description of exemplary embodiments with reference to the attached drawings.

### BRIEF DESCRIPTION OF THE DRAWINGS

FIG. 1 is a processing sequence chart of cloud print.

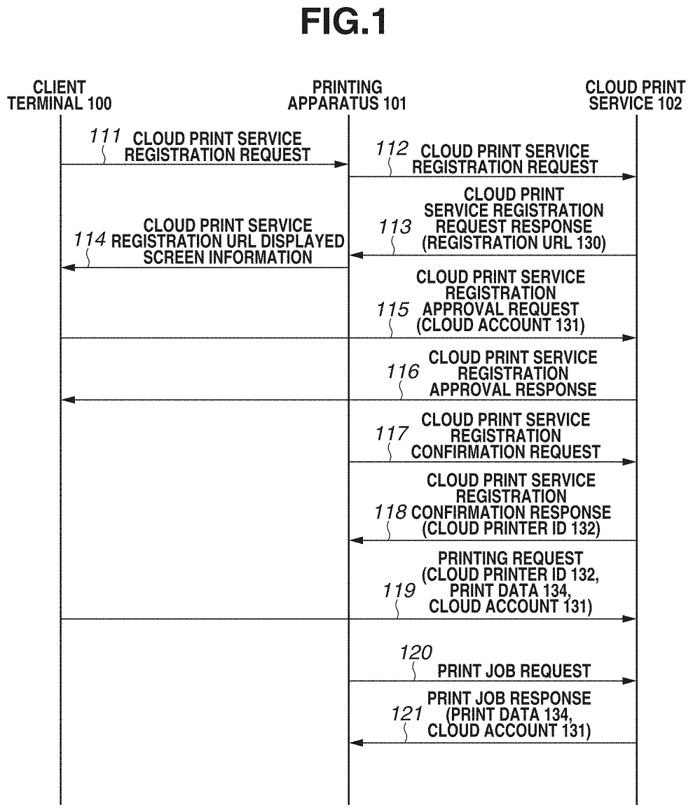

FIG. 2 is a processing sequence chart of an event notification of cloud print (Pull type).

FIG. 3 is a processing sequence chart of an event notification of cloud print (Push type).

FIG. 4 is a block diagram illustrating a hardware configuration of a printing apparatus according to the present exemplary embodiment.

FIG. 5 illustrates a software configuration of the printing apparatus according to the present exemplary embodiment.

FIG. 6 illustrates a console panel of the printing apparatus according to the present exemplary embodiment.

FIG. 7 is a diagram for describing user account information for the printing apparatus.

FIG. 8 is a flowchart illustrating control of a printing apparatus when a user logs in to the printing apparatus according to a first exemplary embodiment.

FIG. 9 is a sequence chart illustrating control of the printing apparatus when the user logs in to the printing apparatus according to the first exemplary embodiment.

FIG. 10 is a flowchart illustrating control when the printing apparatus according to the first exemplary embodiment receives a job reception event.

FIG. 11 is a flowchart illustrating control when a cloud print service according to the first exemplary embodiment receives a print job.

FIG. 12 is a flowchart illustrating control when the cloud print service according to the first exemplary embodiment receives an event notification request for an event notification (Pull type).

FIG. 13 is a flowchart illustrating control of the printing apparatus when a user logs in to a printing apparatus according to a second exemplary embodiment.

FIG. 14 illustrates an operation screen on which a cloud print job list is displayed in the printing apparatus according to the second exemplary embodiment.

FIG. 15 is a flowchart illustrating control when a cloud print job selected by the user is printed in the printing apparatus according to the second exemplary embodiment.

FIG. 16 is a flowchart illustrating control when a printing apparatus according to a third exemplary embodiment receives a job reception event.

FIG. 17 illustrates an operation screen on which a job reception message is displayed in the printing apparatus according to the third exemplary embodiment.

FIG. 18 is a flowchart illustrating control when a printing apparatus according to a fourth exemplary embodiment receives a job reception event.

### DESCRIPTION OF THE EMBODIMENTS

In a cloud print service, when a print job is transmitted to the cloud, a job reception event is notified to a registered printing apparatus. If receiving this job reception event, the printing apparatus acquires a print job from the cloud print service and performs printing based on the print job. On the other hand, printing apparatuses in recent years are required to prevent occurrence of information leakage caused by leaving a printed matter. Even in the cloud print service, when a printing apparatus acquires a print job and performs printing at the time of receiving a job reception event, information leakage may occur by leaving a printed matter.

Embodiments of the present disclosure are directed to a printing apparatus supporting a cloud print service to control a process of printing a print job depending on whether the printing apparatus is operated under a user management.

Exemplary embodiments of the present disclosure will be described below with reference to the drawings. The following exemplary embodiments do not limit the disclosure according to the claims, and all combinations of the features described in the exemplary embodiments are not necessarily essential to means to solve the issues.

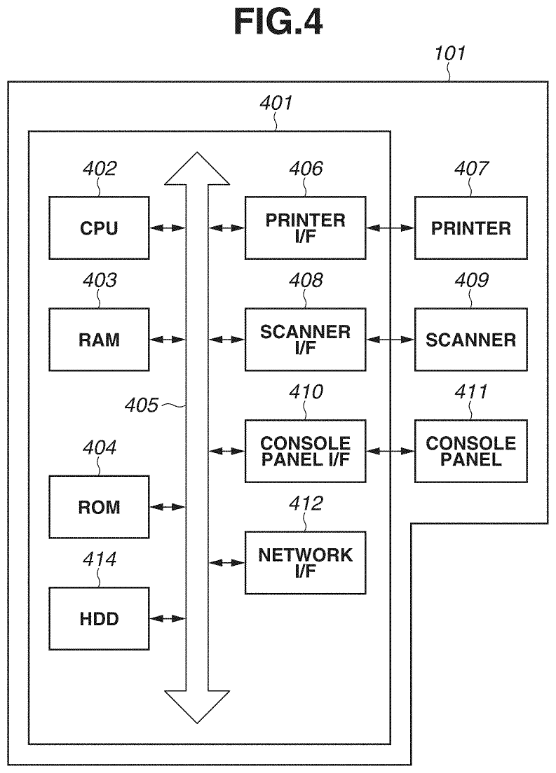

To begin with, FIG. 4 is a block diagram illustrating a hardware configuration of a printing apparatus 101 according to the present exemplary embodiment. A control unit 401 including a central processing unit (CPU) 402 controls the overall operation of the printing apparatus 101. The CPU 402 reads a control program stored in a read-only memory (ROM) 404 to perform various controls such as communication control. A random-access memory (RAM) 403 is used as a main memory of the CPU 402 and a temporarily storage area such as a work area. A hard disk drive (HDD) 414 stores data, various programs, or various information tables.

A printer interface (I/F) 406 serves as an interface for outputting an image signal to a printer 407 (a printer engine). A scanner I/F 408 also serves as an interface for inputting a read image signal from a scanner 409 (a scanner engine). The CPU 402 processes the image signal input from the scanner I/F 408, and outputs the processed image signal to the printer I/F 406 as a recording image signal.

A console panel I/F 410 connects a console panel 411 and the control unit 401. The console panel 411 is provided with a liquid crystal display unit having a touch panel function, a keyboard, and the like. A network I/F 412 transmits information to external terminals such as the client terminal 100 and the cloud print service 102, and receives various types of information from such external apparatuses.

The blocks in the control unit 401 are connected to each other via a system bus 405. The cloud print service 102 is a normal information processing apparatus, and does not include any unit specific to the printing apparatus, such as the printer 407, the scanner 409, and the console panel 411 in FIG. 4.

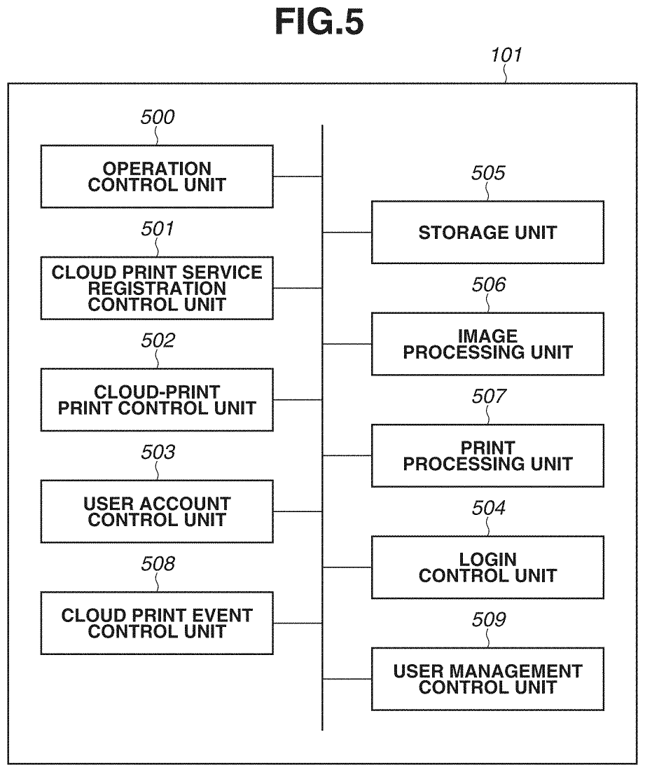

FIG. 5 is a diagram for describing a software configuration of the printing apparatus 101. Functional units illustrated in FIG. 5 are implemented by the CPU 402 of the printing apparatus 101 executing a control program.

An operation control unit 500 controls the console panel 411. While an operation menu is displayed on the console panel 411, an instruction input from a user is awaited. The received content of the instruction is notified to another functional unit, and the instruction result is displayed on the console panel 411.

A cloud print service registration control unit 501 analyzes a cloud print service registration request 111 received from the client terminal 100, and transmits a cloud print service registration request 112 to a cloud print service 102. Thus, a cloud print service registration process is controlled.

A cloud-print print control unit 502 controls a process of transferring print data 134 received from the cloud print service 102 together with a print instruction to an image processing unit 506. A cloud print event control unit 508 controls a process of transmitting and receiving an event between the printing apparatus 101 and the cloud print service 102.

A storage unit 505 stores designated data into the ROM 404 or the HDD 414, or reads out the stored data in response to an instruction from another functional unit. An example of data managed by the storage unit 505 includes user management information of the printing apparatus.

The image processing unit 506 performs a process of rendering a print job into image data for printing. A print processing unit 507 transmits the image data rendered by the image processing unit 506 as an image signal to the printer 407 via the printer I/F 406 to perform a process of printing.

A user account control unit 503 manages user account information stored in the storage unit 505. A login control unit 504 controls a process of logging in to the printing apparatus 101 using the user account information managed by the user account control unit 503.

A user management control unit 509 controls a user management process for the printing apparatus 101. When the user management setting stored in the storage unit 505 is ON, the user management control unit 509 controls the operation control unit 500 to display a login screen. It is assumed that the software configuration of the cloud print service 102 is the same as any of the cloud print services conventionally known.

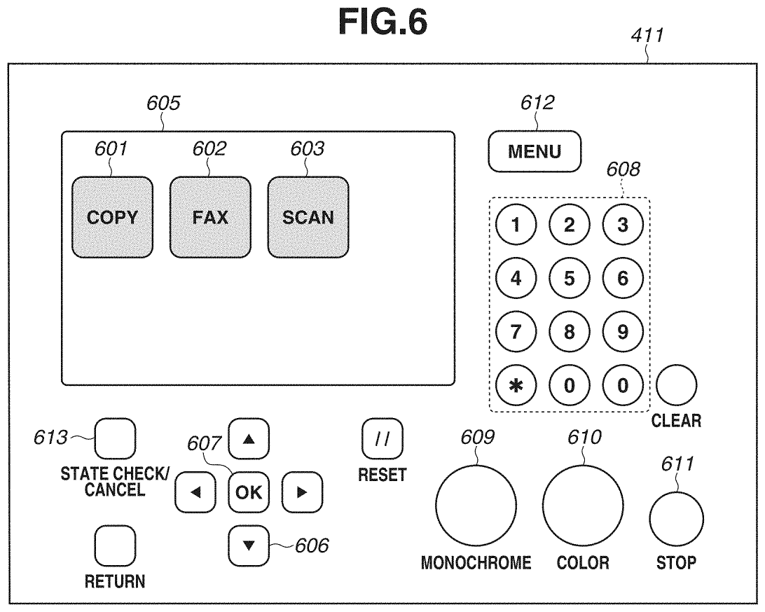

FIG. 6 is a diagram for describing the console panel 411 of the printing apparatus 101. A display panel 605 uses a liquid crystal display (LCD) or the like. A button 601 is pressed when copying is performed using the printing apparatus 101. Pressing this button causes a copy operation screen to be displayed on the display panel 605.

A button 602 is pressed when facsimile (FAX) is performed using the printing apparatus 101. Pressing this button causes a FAX operation screen to be displayed on the display panel 605. A button 603 is pressed when scanning is performed using the printing apparatus 101. Pressing this button causes a scan operation screen to be displayed on the display panel 605. A numeric keypad 608 is used to input numbers and the like.

An OK key 607 is used to determine the display content of the display panel 605, for example. Direction keys 606 are used to select a menu or the like displayed on the display panel 605. A monochrome copy key 609 and a color copy key 610 are used to execute monochrome copying and color copying, respectively. A stop key 611 is used to stop a process. A menu key 612 is used to display a menu screen for performing setting of the printing apparatus 101. A state check/cancel key 613 is used to check the state of the printing apparatus 101, including checking a list of print jobs received by the printing apparatus 101.

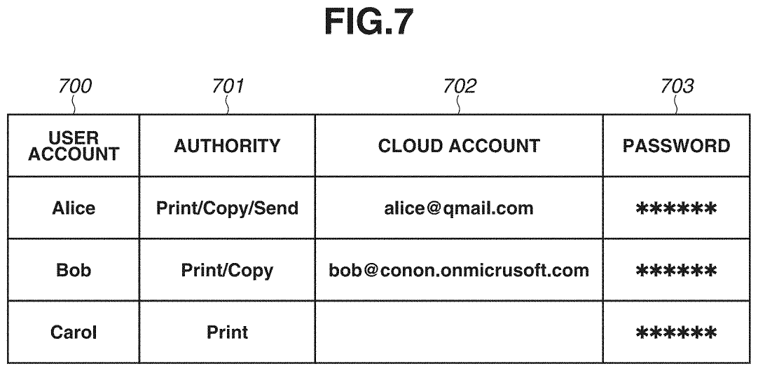

FIG. 7 is a diagram for describing user management information held by the printing apparatus 101. The user management information includes a user account 700, an authority 701, a cloud account 702, and a password 703, which are saved in the storage unit 505.

The user account 700 is ID information for uniquely identifying a user in the printing apparatus 101, and a user authorized to operate the printing apparatus 101 is represented by the user account 700. The authority 701 is information indicating the authority of the corresponding user. The cloud account 702 is information indicating a cloud account associated with the user account 700.

Here, one cloud account 702 is not necessarily to be associated with one user account 700 but a plurality of cloud accounts 702 may be set to be associated with one user account 700. For example, not only alice@qmail.com but also alice@conon.onmicrusoft.com may be associated with Alice. On the other hand, it is not necessary to associate the cloud account 702 with the user account 700, so the cloud account 702 may be blank. The password 703 is information indicating a password required when the user logs in to the printing apparatus 101 with the user account 700.

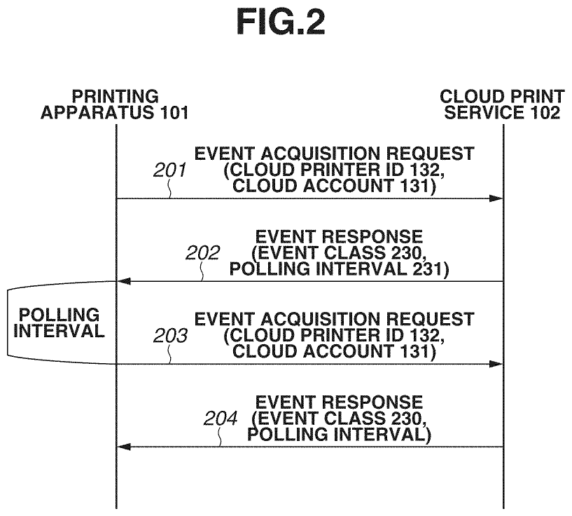

There are two methods for event notification of a print job: Pull type and Push type. FIG. 2 is a diagram for describing a processing sequence of event notification (Pull type). The printing apparatus 101 transmits an event acquisition request 201 including a cloud printer ID 132 and a cloud account 131 to the cloud print service 102.

If receiving the acquisition request 201, the cloud print service 102 transmits, to the printing apparatus 101, an event response 202 including an event class 230 and a polling interval 231. Event information that has occurred is set to the event class. An example of the event information includes a job reception event indicating that a print job addressed to the printing apparatus 101 has been received. When no event has occurred, the event information is not included. The polling interval is used for the cloud print service 102 to notify the printing apparatus 101 of the interval until the printing apparatus 101 transmits a next event acquisition request.

If receiving the response 202, the printing apparatus 101 transmits an event acquisition request 203 including the cloud printer ID 132 and the cloud account 131 to the cloud print service 102 again after the time of the polling interval included in the response 202 elapses. Similarly to the previous time, if receiving the acquisition request 203, the cloud print service 102 transmits an event response 204 including the event class 230 and the polling interval 231 to the printing apparatus 101. Thereafter, the printing apparatus 101 repeats the same process according to the polling interval.

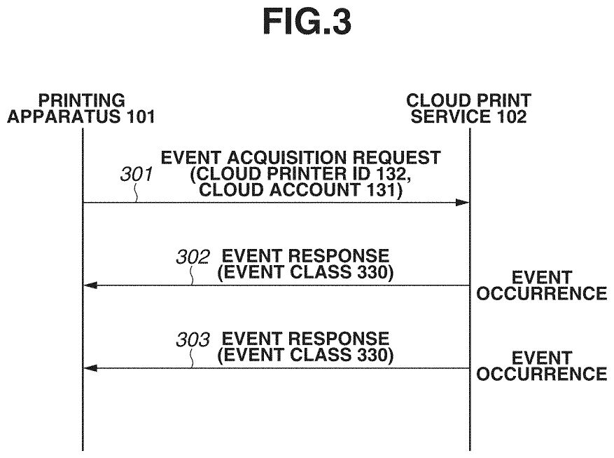

FIG. 3 is a diagram for describing a processing sequence of event notification (Push type). The printing apparatus 101 transmits an event acquisition request 301 including a cloud printer ID 132 and a cloud account 131 to the cloud print service 102. If receiving the event acquisition request 301, the cloud print service 102 transmits an event response 302 including an event class 330 to the printing apparatus 101.

Event information that has occurred is set to the event class. An example of the event information includes a job reception event indicating that a print job addressed to the printing apparatus 101 has been received. When no event has occurred, the event information is not included.

The printing apparatus 101 continues to maintain the network connection to the cloud print service 102 still after receiving the event response 302. When an event occurs, the cloud print service 102 transmits the event responses 302 and 303 including the event class 330 via the network connection at the timing of occurrence of the event.

An operation of the printing apparatus 101 according to exemplary embodiments when a cloud print is executed will be described below. A second exemplary embodiment and the subsequent exemplary embodiments will be described focusing on differences from a first exemplary embodiment.

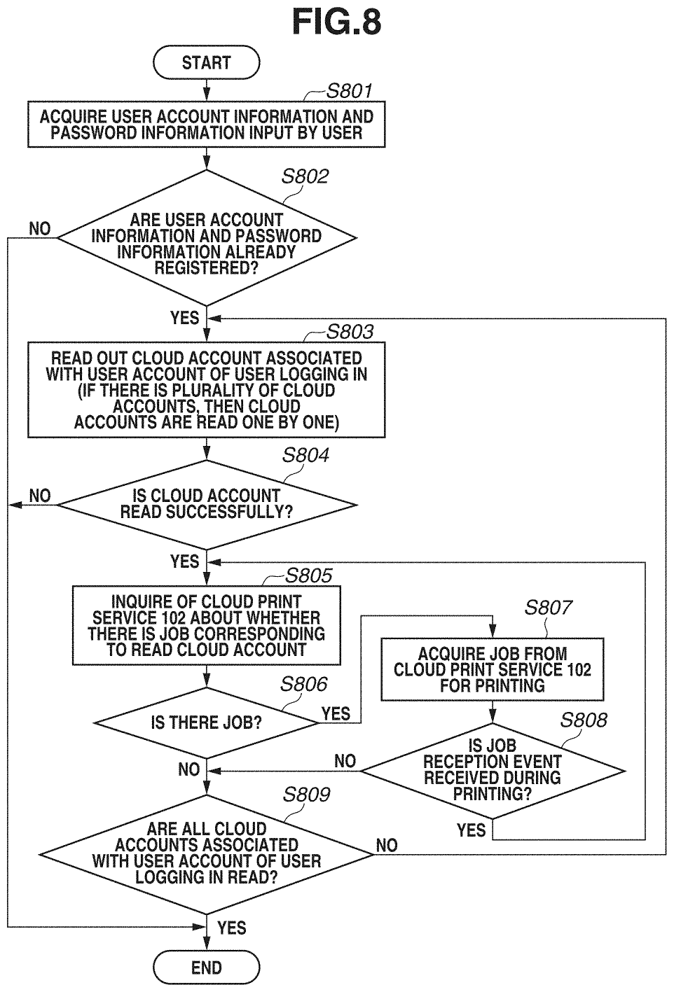

A first exemplary embodiment will be described. FIG. 8 is a flowchart illustrating control of the printing apparatus 101 when a user logs in to the printing apparatus 101. The user operates the console panel 411 to perform a login operation. In step S801, the operation control unit 500 passes, to the login control unit 504, the user account information and the password information which have been input through the login operation.

In step S802, the login control unit 504 confirms whether the passed information is registered in the user accounts 700 and the passwords 703 in the user management information. If the registration cannot be confirmed (No in step S802), login failure is determined, and the processing ends. If the registration can be confirmed (Yes in step S802), login successful is determined, and the processing proceeds to step S803. If the login is successful, the user account control unit 503 reads the cloud account associated with the user account of a user logging in from the user management information stored in the storage unit 505 in step S803.

A plurality of cloud accounts may be associated with the user account. In that case, in step S803, the associated cloud accounts are read one by one. It is assumed that an inquiry in step S805 is the Pull type illustrated in FIG. 2. In step S804, if the reading is failed or if no cloud account is registered (No in step S804) by the user account control unit 503, the processing ends. If the reading is successful (Yes in step S804), the cloud-print print control unit 502 inquires of the cloud print service 102 about whether there is a print job corresponding to the read cloud account in step S805.

If the result of the inquiry indicates that there is no print job (No in step S806), the cloud-print print control unit 502 determines whether all of the cloud accounts associated with the user account of a user logging in have been read in step S809. If all of the cloud accounts have been read (Yes in step S809), the processing ends. If all of the cloud accounts have not been read (No in step S809), the processing returns to step S803 to read a next cloud account, acquire a job, and repeat the process of printing.

In step S806, if it is determined that there is a print job (Yes in step S806), the cloud-print print control unit 502 acquires the job from the cloud print service 102 in step S807. Then, the image processing unit 506 renders the acquired data. The print processing unit 507 prints the rendered image data. While the cloud-print print control unit 502 executes printing in step S807, the cloud print event control unit 508 determines whether a job reception event addressed to a cloud account that is being subjected to logging in has been received in step S808. If a job reception event has not been received (No in step S808), the processing proceeds to step S809.

If a job reception event has been received (Yes in step S808), the cloud-print print control unit 502 repeats the inquiry process of step S805. A print job acquisition resulting from reception of a job reception event is based on the Push type in FIG. 3, and the print job acquisition is performed for all the read accounts.

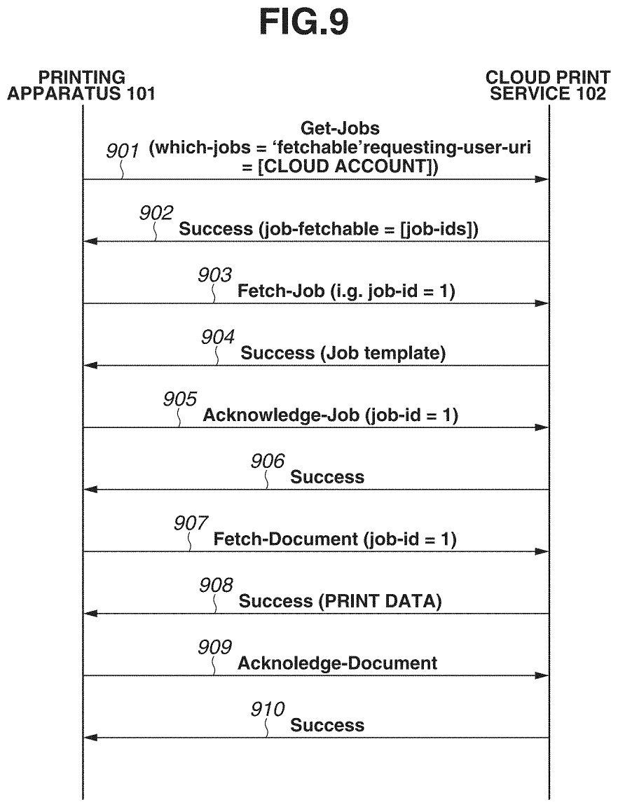

FIG. 9 is a sequence chart illustrating an example of a specific communication process between the printing apparatus 101 and the cloud print service 102 when the user logs in to the printing apparatus 101. The present exemplary embodiment will be described using the Internet Printing Protocol (IPP) as a protocol between the printing apparatus 101 and the cloud print service 102. The sequence of the inquiry process described in step S805 in FIG. 8 corresponds to 901 and 902.

The printing apparatus 101 transmits a Get-Jobs request 901 to the cloud print service 102. At this time, ‘fetchable’ is set to a which-jobs attribute, and the cloud account associated with the user account of a user logging in is set to a requesting-user-uri attribute. This makes it possible to inquire whether there is a receivable print job addressed to the cloud account. If there is a receivable print job addressed to the inquired cloud account, the cloud print service 102 transmits a Success response 902 to the printing apparatus 101. At this time, a job-id is set to a job-fetchable attribute.

If no cloud account is associated with the user account, the inquiry of a print job is not performed. That is, since there is no cloud account, it is determined that a user logging in to the printing apparatus 101 does not use the cloud print service, and the Get-Jobs request 901 will not be transmitted accordingly. The sequence of the print job acquisition and the print process described in step S807 of FIG. 8 corresponds to 903 to 910.

The printing apparatus 101 transmits a Fetch-Job request 903 to the cloud print service 102 to request print settings for the job. At this time, the job-id acquired in the Success response 902 is set to the job-id attribute. The cloud print service 102 transmits a Success response 904 to the printing apparatus 101. At this time, the print setting for the job is set to a job-template attribute.

If successfully receiving the print setting for the job by the Success response 904, the printing apparatus 101 transmits an Acknowledge-Job request 905 to the cloud print service 102. At this time, the job-id acquired in the Success response 902 is set to the job-id attribute. If receiving the Acknowledge-Job request 905, the cloud print service 102 transmits a Success response 906 to the printing apparatus 101.

If successfully receiving the print setting for the job by the Success response 904, the printing apparatus 101 transmits a Fetch-Document request 907 to the cloud print service 102. This makes a request for print data.

At this time, the job-id acquired in the Success response 902 is set to the job-id attribute. The cloud print service 102 transmits a Success response 908 to the printing apparatus 101. At this time, print data is simultaneously transmitted.

If successfully receiving the print data by the Success response 908, the printing apparatus 101 transmits an Acknowledge-Document request 909 to the cloud print service 102. At this time, the job-id acquired by the Success response 902 is set to the job-id attribute. If receiving the Acknowledge-Document request 909, the cloud print service 102 transmits a Success response 910 to the printing apparatus 101.

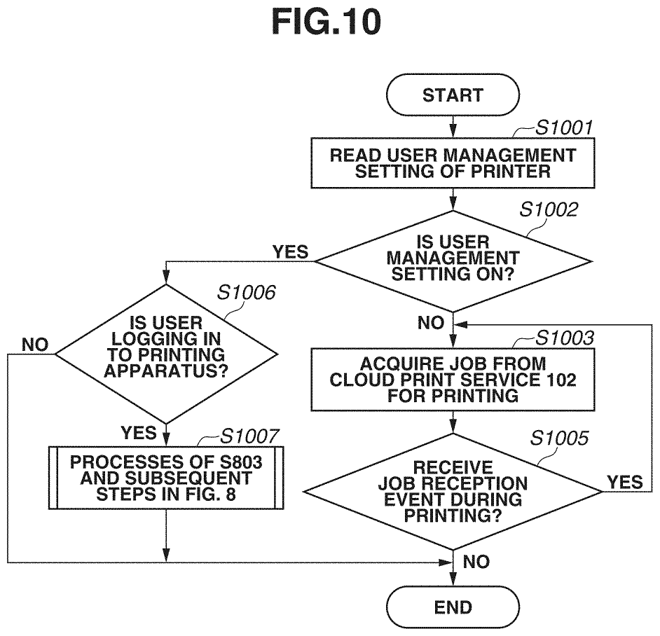

FIG. 10 is a flowchart illustrating control when the printing apparatus 101 receives a job reception event. When the job reception event is received, the user management control unit 509 reads the user management setting for the printer from the storage unit 505 in step S1001. Here, the state where the user management setting is performed indicates a state where the operation of the printing apparatus for each user is managed and controlled. In this state, login is required to allow the user to operate the printing apparatus 101 using the console panel 411.

In step S1002, the user management control unit 509 determines whether the user management setting is ON, and if the user management setting is ON (Yes in step S1002), the processing proceeds to step S1006. In step S1006, the login control unit 504 confirms whether the user is in a state of logging in to the printing apparatus 101. If the user is in the state of logging in the printing apparatus 101 (Yes in step S1006), the processes of step S803 and the subsequent steps in FIG. 8 are performed in step S1007. If the user is not in the state of logging in the printing apparatus 101 (No in step S1006), the processing ends.

If the user management setting is OFF (No in step S1002), the cloud-print print control unit 502 acquires a job from the cloud print service 102 and performs printing in step S1003. If the printing apparatus 101 does not have the user management setting function itself, the process of step S1003 is performed as in the case where the user management setting is OFF. When the printing is complete, the cloud print event control unit 508 determines whether a job reception event has been received during the printing in step S1005. If a job reception event has not been received (No in step S1005), the processing ends.

If a job reception event has been received (Yes in step S1005), the operation returns to step S1003 to repeat the print process. The difference between step S1003 and step S1007 will be described just in case. In step S1003, printing is performed for the job of any user account. In step S1007, printing is performed only for the job corresponding to the user account of a user who is set to the printing apparatus 101 and who has logged in. In other words, if the user management setting is ON (Yes in step S1002), that is, the setting is enabled, the job carelessly input to the cloud print service 102 is not printed, thereby making it possible to maintain the confidentiality. The printing apparatus 101 according to the first exemplary embodiment has two methods, and acquires and prints a print job by any one of the methods.

Here, an example of a specific communication process between the printing apparatus 101 and the cloud print service 102 in step S1003 is the same as that described in FIG. 9. However, since a user is not managed, the requesting-user-uri attribute of the Get-Jobs request 901 is not set. Thus, it is possible to inquire about all receivable jobs addressed to the printing apparatus 101 regardless of the cloud account of the transmission source.

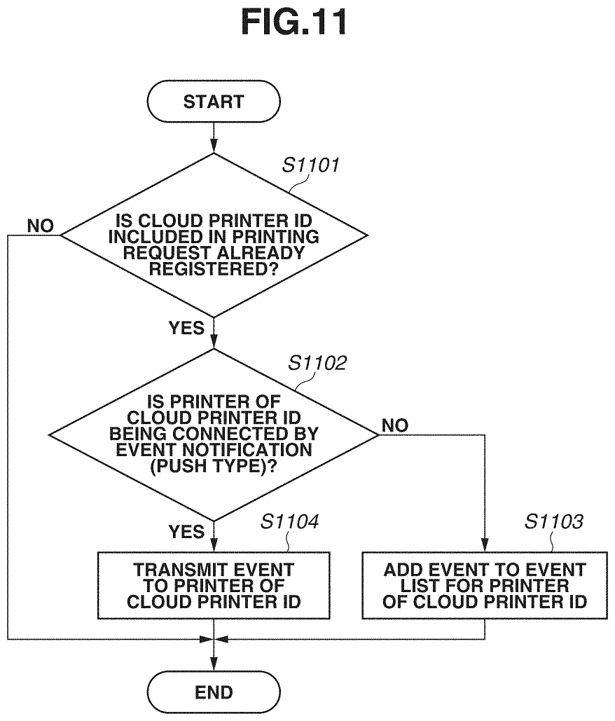

FIG. 11 is a flowchart illustrating control when the cloud print service 102 receives a print job. The cloud print service 102 receives a printing request 119 from the client terminal 100. In step S1101, the cloud print service 102 determines whether a cloud printer of the cloud printer ID 132 included in the printing request 119 is a registered cloud printer (printing apparatus 101).

If the cloud printer of the cloud printer ID 132 is not yet registered (No in step S1101), the processing ends. If the cloud printer of the cloud printer ID 132 is already registered (Yes in step S1101), the cloud print service 102 determines whether the event notification type for the printer of the cloud printer ID 132 is the Push type or the Pull type in step S1102. If the type is the Push type (Yes in step S102), the cloud print service 102 transmits an event through the Push type transmission to the printer of the cloud printer ID 132 in step S1104.

If the type is not the Push type (i.e., in the case of the Pull type) (No in step S1102), the cloud print service 102 adds the job reception event to an event list for the printer of the cloud printer ID 132 in step S1103. An event managed in the event list is used as an event notified as the event response 202 when the cloud print service 102 receives the event acquisition request 201 from the client terminal 100.

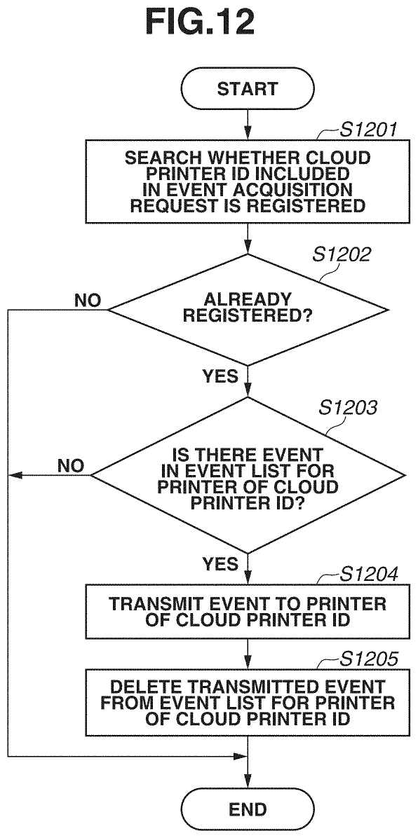

FIG. 12 is a flowchart illustrating control when the cloud print service 102 receives an event acquisition request (Pull type). The cloud print service 102 receives the event acquisition request 201 from the client terminal 100.

In step S1202, the cloud print service 102 determines whether a cloud printer of the cloud printer ID 132 included in the event acquisition request 201 is a registered cloud printer. If a cloud printer of the cloud printer ID 132 is not yet registered (No in step S1202), the processing ends. If a cloud printer of the cloud printer ID 132 is already registered (Yes in step S1202), the cloud print service 102 determines whether there is an event in the event list for the printer of the cloud printer ID 132 in step S1203.

If there is no event (No in step S1203), the cloud print service 102 transmits the event response 202 not including an event to the printing apparatus 101 in step S1204. If there is an event (Yes in step S1203), the cloud print service 102 transmits the event response 202 including the event included in the event list to the printing apparatus 101 in step S1204. Then, the cloud print service 102 deletes the transmitted event from the event list for the printer of the cloud printer ID 132 in step S1205.

The above description is for the first exemplary embodiment, and the effects by the operations illustrated in FIGS. 8 and 10 are that the possibility of a confidential document being leaked is reduced only when the user management setting for the printing apparatus 101 is enabled.

The second exemplary embodiment will be described. In the first exemplary embodiment, as described with reference to FIG. 8, when the user logs in to the printing apparatus 101 as a trigger, all the cloud print jobs of the user are acquired to perform printing. However, there may be a case where some users do not desire to automatically execute printing at a timing of logging in to the printing apparatus 101. The second exemplary embodiment is an exemplary embodiment designed in consideration of such a case.

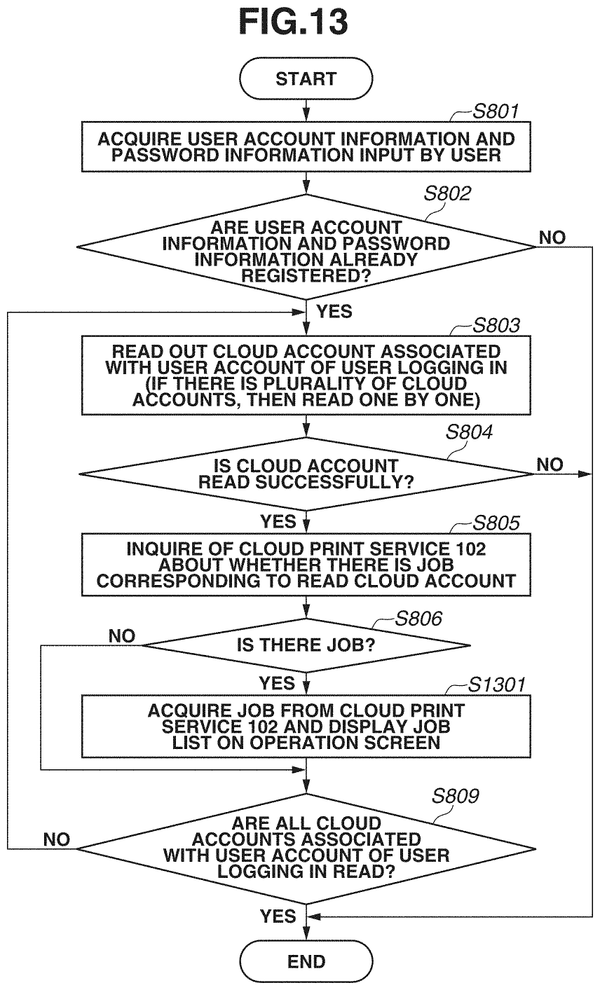

FIG. 13 is a flowchart illustrating control of the printing apparatus 101 when the user logs in to the printing apparatus 101 according to the second exemplary embodiment. Here, the processes of steps S801 to S806 and S809 are the same as the contents described in FIG. 8. Therefore, only the process of step S1301 after step S806 will be described.

If the result of the inquiry in step S806 indicates that there is no print job (No in step S806), the processing ends. If there is a print job (Yes in step S806), the cloud-print print control unit 502 acquires the job from the cloud print service 102 in step S1301. Then, the operation control unit 500 displays a cloud print job list on the display panel 605.

The job information acquisition process described here may not be executed at a timing at which the user logged in, but may be executed at a timing at which the user operates the console panel 411 of the printing apparatus 101 to display the cloud print job list. Furthermore, the job information acquisition process may be executed at a timing at which the printing apparatus 101 receives a job reception event, and the printing apparatus 101 may be configured to store the information in the storage unit 505. In this case, when the user operates the console panel 411 of the printing apparatus 101 to display the cloud print job list, the printing apparatus 101 displays the job information stored in the storage unit 505.

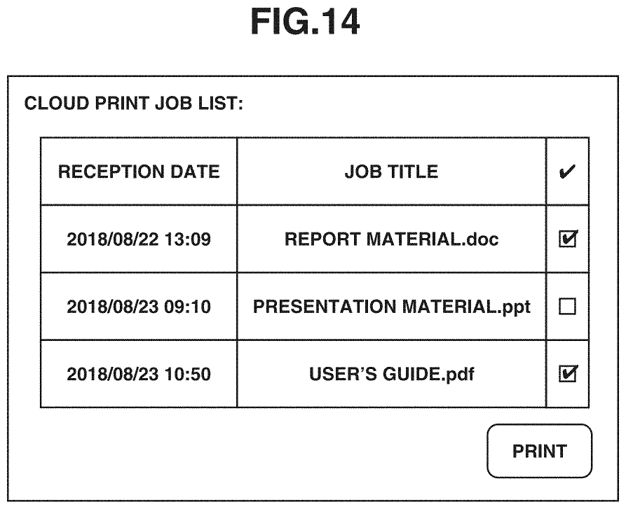

FIG. 14 is a diagram illustrating an operation screen on which the cloud print job list is displayed in the printing apparatus 101 according to the second exemplary embodiment. This operation screen is a screen displayed in step S1301 of FIG. 13. The reception date indicates the date when each cloud print job has been transmitted to the cloud print service 102. The job title indicates the title of the cloud print job. The check box can be set with or without check. When the print button is pressed, the printing apparatus 101 acquires the job for which the check box has been checked from the cloud print service 102 to print the job.

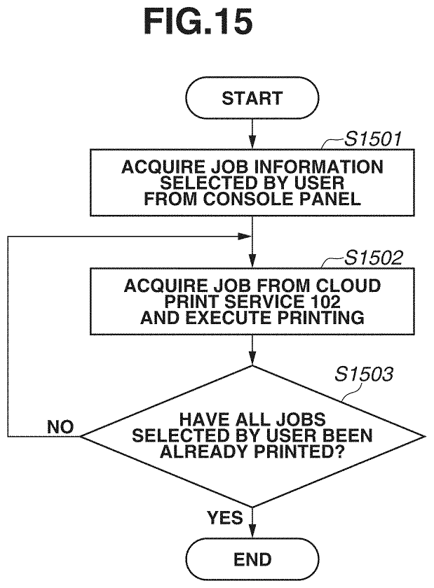

FIG. 15 is a flowchart illustrating control when a cloud print job selected by the user is printed in the printing apparatus 101 according to the second exemplary embodiment. The operation control unit 500 acquires job information selected by the user using the console panel 411 in step S1501. In step S1502, the cloud-print print control unit 502 acquires the job selected by the user from the cloud print service 102 to execute printing.

In step S1503, the cloud-print print control unit 502 determines whether printing of all the jobs selected by the user has been executed. If the printing of all the jobs has been executed (Yes in step S1503), the processing ends. If the printing of all the jobs has not been executed (No in step S1503), the operation returns to step S1502 to repeat the print process.

The second exemplary embodiment can deal with the case where the user does not desire to automatically execute the printing at the timing of logging in to the printing apparatus 101. The second exemplary embodiment has been described as an alternative to the first exemplary embodiment, but both may coexist. For example, if printing of a print job simultaneously with the login is set, the printing is performed by the method according to the first exemplary embodiment, and if printing of a print job in response to the user instruction for printing the job after the user logs in and selects the job is set, the printing is performed by the method according to the second exemplary embodiment.

A third exemplary embodiment will be described. In the first exemplary embodiment, as described with reference to FIG. 10, if a job reception event is received during login, the job is also automatically printed. However, there may be a case where some users do not desire to automatically execute printing at a timing of logging in to the printing apparatus 101. The third exemplary embodiment is designed in consideration of such a case.

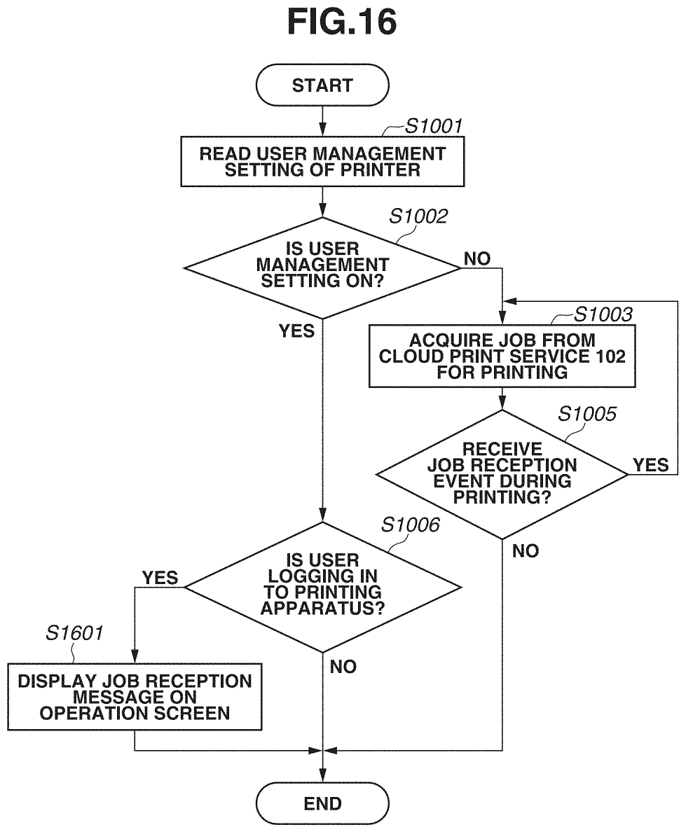

FIG. 16 is a flowchart illustrating control when the printing apparatus 101 according to the third exemplary embodiment receives a job reception event. Here, the processes of steps S1001 to S1006 are the same as the contents described in FIG. 10. Therefore, only the processes after step S1006 will be described.

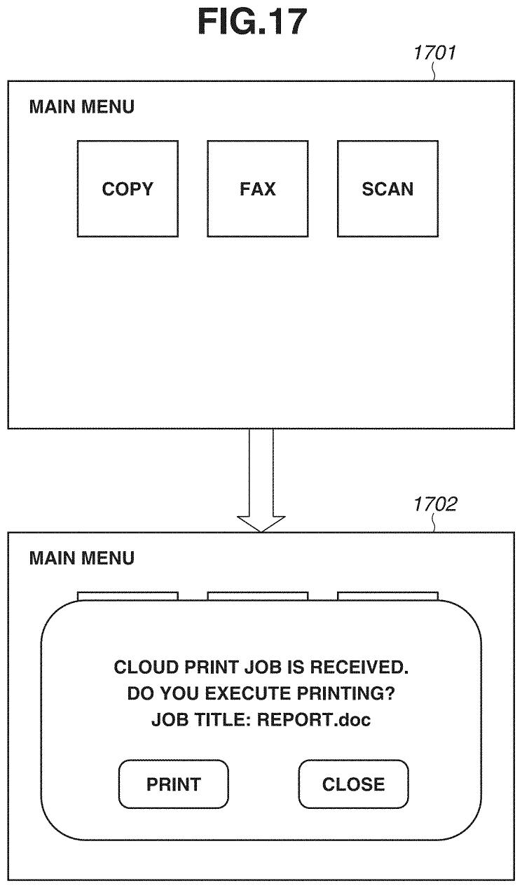

If the cloud-print print control unit 502 determines that the user is logging in to the printing apparatus 101 in step S1006 (Yes in step S1006), the cloud-print print control unit 502 displays a job reception message on the operation screen. FIG. 17 illustrates an operation screen on which a job reception message is displayed in the printing apparatus 101 according to the third exemplary embodiment. This operation screen is a screen displayed in step S1301 of FIG. 13.

This operation screen is a screen displayed in S1301 of FIG. 13. If the printing apparatus 101 receives a job reception event from the cloud print service 102, a pop-up screen as illustrated in an operation screen 1702 is displayed.

On the pop-up screen, the job title of the corresponding cloud print job is displayed. Here, when the print button is pressed, the cloud-print print control unit 502 acquires the displayed job from the cloud print service 102 to print the job. When the close button is pressed, the pop-up screen is closed without performing printing.

The third exemplary embodiment may be in the form of coexistence with the first exemplary embodiment as in the second exemplary embodiment. In addition, the third exemplary embodiment can coexist with the second exemplary embodiment, for example, by the setting of switching the printing method between the methods according to the second exemplary embodiment and the third exemplary embodiment.

A fourth exemplary embodiment will be described. In the first exemplary embodiment, as described with reference to FIG. 10, if a job reception event is received with the user management setting being ON, the following operations are performed. If the cloud account of the job transmission source is not included in the cloud account 702 in the user management information managed by the printing apparatus 101, printing is not executed. However, there may be a case where some users want to unconditionally print any cloud print job from a cloud account not managed by the printing apparatus 101. The fourth exemplary embodiment is designed in consideration of such a case.

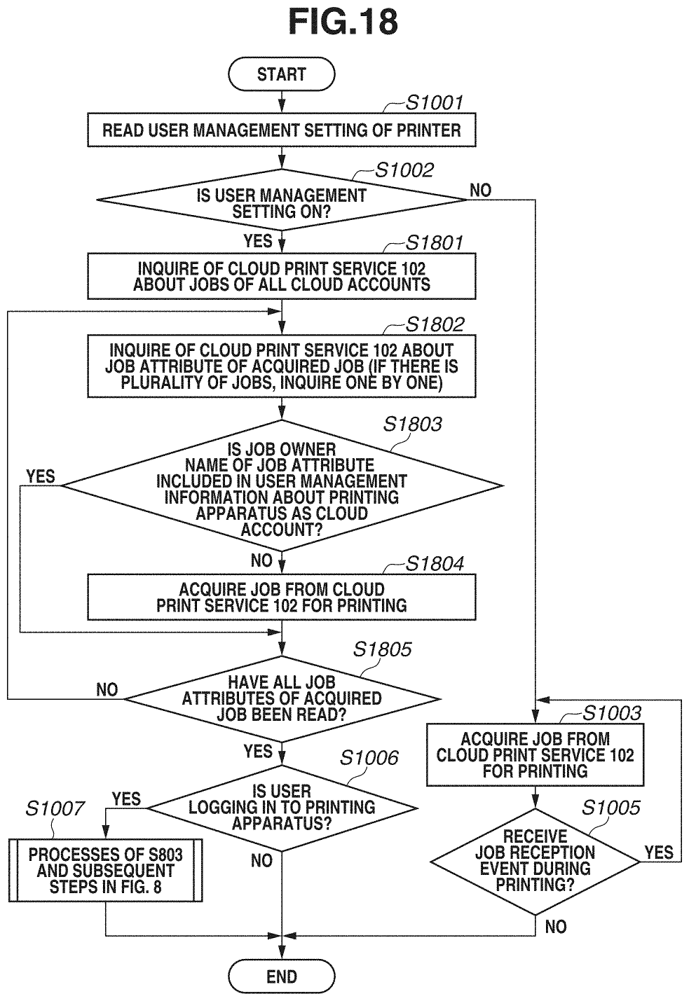

FIG. 18 is a flowchart illustrating control when the printing apparatus 101 according to the fourth exemplary embodiment receives a job reception event. Here, the processes of steps S1001 to S1007 are the same as the contents described in FIG. 10. Therefore, only the processes of step S1801 and the subsequent steps when the user management setting is ON in step S1002 (Yes in step S1002) will be described.

If the user management setting is ON in step S1002 (Yes in step S1002), the cloud-print print control unit 502 inquires of the cloud print service 102 about jobs for all the cloud accounts in step S1801. In a specific example of the IPP, the inquiry is made by transmitting the Get-Jobs request 901 described with reference to FIG. 9. Here, the requesting-user-uri attribute of the Get-Jobs request 901 is not set.

In step S1802, the cloud-print print control unit 502 inquires of the cloud print service 102 about the job attribute of the acquired job. In the specific example of the IPP, the inquiry is made by transmitting the Fetch-Job request 903 described with reference to FIG. 9. The job-id acquired in step S1801 is set to the job-id attribute set in the Fetch-Job. When a plurality of job-ids is acquired in step S1801, the job-ids are set one by one.

In step S1803, the cloud-print print control unit 502 confirms whether the job owner name of the acquired job attribute is included in the user management information about the printing apparatus 101 as a cloud account. If the job owner name is included (Yes in step S1803), then nothing is performed and it is determined whether all the job attributes of the acquired job have been read in step S1805.

If all the job attributes have not been read (No in step S1805), the operation returns to step S1802 to repeat the inquiry process for the job attribute. If all the job attributes have been read (Yes in step S1805), the processing proceeds to step S1006. If the job owner name of the job attribute acquired in step S1803 is not included in the user management information about the printing apparatus 101 as a cloud account (No in step S1803), the cloud-print print control unit 502 acquires the job from the cloud print service 102 to perform printing in step S1804. Next, the processing proceeds to step S1805.

In the fourth exemplary embodiment that is a modification of the first exemplary embodiment, a job is permitted to be printed as long as the job is for the cloud account not managed by the printing apparatus 101 even if the printing apparatus 101 is set not to perform printing when there is no login. As a result, while a confidential document of the user to be managed by the printing apparatus 101 is held, printing of a document of the user not to be managed by the printing apparatus 101 is performed, which improves the convenience as compared to the first exemplary embodiment.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-185424, filed Sep. 28, 2018, which is hereby incorporated by reference herein in its entirety.

What is claimed is:

1. A printing apparatus comprising a printing unit configured to acquire a print job from a cloud print service and perform printing based on the acquired print job, the printing apparatus comprising:
a setting unit configured to perform a setting for associating a user account for the printing apparatus with a cloud account for the cloud print service; and
a login unit configured to perform a process of logging in to the printing apparatus based on the user account,
wherein the printing unit determines one method based on a user setting from among two methods of a first method of printing a print job for the cloud account associated with the user account under a condition that the process of logging in to the printing apparatus has been performed by the login unit, and a second method of printing a print job notified by an event notification in response to receiving the event notification from the cloud print service even when the process of logging in to the printing apparatus has not been performed by the login unit, and the printing unit prints a print job by the determined one method.

2. The printing apparatus according to claim 1, further comprising a determination unit configured to determine whether the printing apparatus is set such that a user management setting for permitting use of the printing apparatus is used in a case where the process of logging in to the printing apparatus is performed by the login unit,
wherein the printing unit prints a print job by the first method if the determination unit determines that the printing apparatus is set such that the user management setting is used.

3. The printing apparatus according to claim 2, wherein the printing unit prints a print job by the second method if the determination unit determines that the printing apparatus is not set such that the user management setting is used.

4. The printing apparatus according to claim 1, wherein the printing unit, if printing a print job by the first method, does not inquire of the cloud print service about a print job in a case where the cloud account is not associated with the user account that has been used for the process of logging in to the printing apparatus.

5. The printing apparatus according to claim 1,
wherein the user account includes a plurality of user accounts, the cloud account includes a plurality of cloud accounts, and the setting unit is able to set one of the user accounts in association with a plurality of the cloud accounts, and
wherein the printing unit, if printing a print job by the first method, reads a plurality of the cloud accounts associated with the user account that has been used for the process of logging in to the printing apparatus, and prints print jobs for the plurality of cloud accounts.

6. The printing apparatus according to claim 1, wherein the printing unit, if printing a print job by the first method, displays a job list of print jobs for the cloud account associated with the user account on an operation screen, and prints a print job in response to a user instruction for printing after a user selects the print job from the operation screen.

7. The printing apparatus according to claim 1, wherein the printing unit, if printing a print job by the first method, confirms whether to print a print job for the cloud account associated with the user account, and prints the print job in response to the confirmation of printing the print job.

8. The printing apparatus according to claim 1, wherein the printing unit, if printing a print job by the first method, prints a print job notified by an event notification only in a case where the event notification of the cloud account not set to the printing apparatus is received even when the process of logging in to the printing apparatus has not been performed by the login unit.

9. A method of controlling a printing apparatus comprising a printing unit configured to acquire a print job from a cloud print service and perform printing based on the acquired print job, the method comprising:
performing a setting for associating a user account for the printing apparatus with a cloud account for the cloud print service; and
performing a process of logging in to the printing apparatus based on the user account,
wherein the printing performed by the printing unit includes determining one method based on a user setting from among two methods of a first method of printing a print job for the cloud account associated with the user account under a condition that the process of logging in to the printing apparatus has been performed by the login unit, and a second method of printing a print job notified by an event notification in response to receiving the event notification from the cloud print service even when the process of logging in to the printing apparatus has not been performed by the login unit, and printing a print job by the determined one method.

10. A non-transitory storing medium storing a program of a printing apparatus comprising a printing unit configured to acquire a print job from a cloud print service and perform printing based on the acquired print job, the program including instructions, which when executed by one or more processors of the printing apparatus, cause the printing apparatus to execute:
performing a setting for associating a user account for the printing apparatus with a cloud account for the cloud print service; and
performing a process of logging in to the printing apparatus based on the user account,
wherein the printing performed by the printing unit includes determining one method based on a user setting from among two methods of a first method of printing a print job for the cloud account associated with the user account under a condition that the process of logging in to the printing apparatus has been performed by the login unit, and a second method of printing a print job notified by an event notification in response to receiving the event notification from the cloud print service even when the process of logging in to the printing apparatus has not been performed by the login unit, and printing a print job by the determined one method.
